(19) United States
(12) Patent Application Publication
(10) Pub. No.: US 2004/0139831 A1
(43) Pub. Date: Jul. 22, 2004

(54) Interchangeable driver for tool bits

(76) Inventor: Gyula Kalder Nagy, Winnipeg (CA)

Correspondence Address: ADE & COMPANY, 1700-360 MAIN STREET, WINNIPEG, MB, R3C3Z3, CA

(21) Appl. No.: 10/348,338

(22) Filed: Jan. 22, 2003

(51) Int. Cl. B25G 1/08

(52) U.S. Cl. 81/490

(57) ABSTRACT

A tool for housing and supplying bits by which they can be driven such as a screw driver or drill has a housing with an elongate tube extending through the housing along the axis to a forward presentation end of the tube at which the bits are presented for use. The housing has a rotatable storage holder mounted in the housing for holding and storing a plurality of tool bits and arranged by manual engagement with an exposed side portion to rotate about a second axis parallel to the tube. The rotatable holder has a plurality of receptacles each for receiving a respective one of the tool bits arranged parallel to the second axis and in angularly spaced relation around the second axis. The rotatable holder is manually rotated to cause each receptacle in turn to move to a position aligned with the tube where a plunger mounted within the tube is moved forward and rearward therein from a retracted position, in which a forward end of the plunger is retracted rearwardly of the holder, to a forward position adjacent the forward presentation end. The plunger has a flat magnetic bit carrying face at the forward end. The holder is rotatable in the housing when the plunger is moved to the retracted position to move the bit off the flat face. The housing includes a drive member which may be just a manual rotation of the housing for causing rotation of the tube and thus the bit at the forward presentation end.

The present invention relates to a driver which has a plurality of bits that are interchangeable within the driver.

### BACKGROUND OF THE INVENTION

A tool such as a screwdriver or the like, generally, comprises a handle that has a portion which extends forwardly for rotation a single type of screw. Some screwdrivers are adapted to allow an operator to change the bit for use with different types of screws so that only one screwdriver is needed in place of many different types. These changeable screwdrivers, generally, require the operator to manually remove the bit from the screwdriver and replace it with an new one, which causes a chance that the bit may be lost or misplaced. Many times the bits are held in the handle which can be opened to allow access.

The driver of the present invention can be used for screw driving bits, sockets, drill bits or other bits which have a different operation and need to be changed within the driver for different jobs. Driving can be effected manually simply by rotating the housing or a motor can be provided within the housing for rotation the tube while the housing is held stationary.

### SUMMARY OF THE INVENTION

It is one object of the present invention to provide an improved driver which reduces the chance of losing the bits by maintaining the bits internally without having to manually remove and replace the ends.

According to the present invention there is provided a tool comprising:

a housing having a first axis therealong;

an elongate tube having a hollow interior and extending through the housing along the first axis to a forward presentation end of the tube;

the housing having a second axis adjacent to and parallel to the first axis;

a rotatable storage holder mounted in the housing for holding and storing a plurality of tool bits and arranged to rotate about the second axis;

the rotatable holder including a plurality of receptacles each for receiving a respective one of the tool bits, the receptacles being arranged parallel to the second axis and in angularly spaced relation around the second axis;

the rotatable holder and the first and second axes being arranged such that rotation of the holder causes each receptacle in turn to move from an operating position aligned with the first axis to a storage position spaced from the first axis;

a plunger mounted within the tube for forward and rearward movement therein from a retracted position, in which a forward end of the plunger is retracted rearwardly of the holder, to a forward position adjacent the forward presentation end;

the plunger having a bit carrying head at the forward end for carrying a bit from that receptacle of the holder which is in the operating position from the receptacle forwardly along the tube to the presentation end;

the holder being rotatable in the housing when the plunger is moved to the retracted position to move the receptacles to carry the bits from the operating position to the storage positions;

and a drive member on the housing for causing rotation of the bit at the forward presentation end.

Preferably the rotatable holder has a majority of its peripheral surface contained within the housing leaving only one portion exposed outside the housing for manual engagement such that the holding means can be rotated.

Preferably the housing includes a generally cylindrical outer surface with an opening therein at which the portion is exposed and the rotatable holder includes a generally cylindrical outer surface of smaller diameter with the portion extending outside the opening.

Preferably the head of the plunger is magnetic which enables the plunger to hold the bit and to pull the bit back from the presentation end to the holder.

Preferably the head of the plunger includes a flat front face for contacting a flat rear face of the bit such that rotation of the holder sweeps the bit off the flat face of the head.

Preferably the plunger includes a coupling for attachment to the housing when in the forward position such that thrust forces applied to the bit toward the housing are communicated through the plunger to the housing.

Preferably the tube includes a portion rearward of the holder for receiving the head.

Preferably the tube includes a shoulder for engaging an abutment on the plunger to prevent rearward retraction beyond the retracted position.

Preferably the drive member on the housing is provided by a coupling between the tube and the bit by which rotation of the bit in the tube is prevented so that rotation of the tube causes rotation of the bit. This is effectively provided by a forward part of the tube which is polygonal for co-operation with a polygonal portion of the bit. Thrust forces on the bit are therefore communicated through the plunger and rotational forces through the tube.

In one embodiment, the tube is simply fixed to the housing such that rotation of the tube is caused by manual rotation of the housing, in the form of a screw driver or the like.

The tube, in the screw driver format, includes a forward tubular duct projecting forwardly of the housing and a portion formed as a bore within the housing.

Preferably the housing includes a window opposite the holder for viewing the bit aligned with the axis.

The driver of the present invention can be used for screw driving bits, sockets, drill bits or other bits which have a different operation and need to be changed within the driver for different jobs. Driving can be effected manually simply by rotating the housing or a motor can be provided within the housing for rotation the tube while the housing is held stationary. In a simple form therefore the tool defines a manual driver for screws or other fasteners

### BRIEF DESCRIPTION OF THE DRAWINGS

Embodiments of the invention will now be described in conjunction with the accompanying drawings in which:

FIG. 1 is a side elevational view of one embodiment of the present invention.

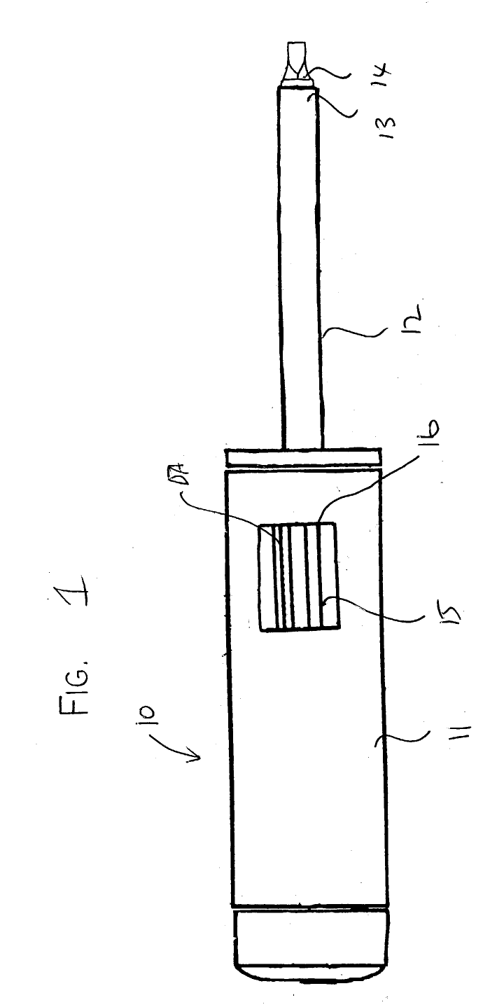

FIG. 2 is an exploded view of the embodiment shown in FIG. 1.

FIG. 3 is a longitudinal cross-sectional view of an embodiment similar to that of FIG. 1 but with minor modifications.

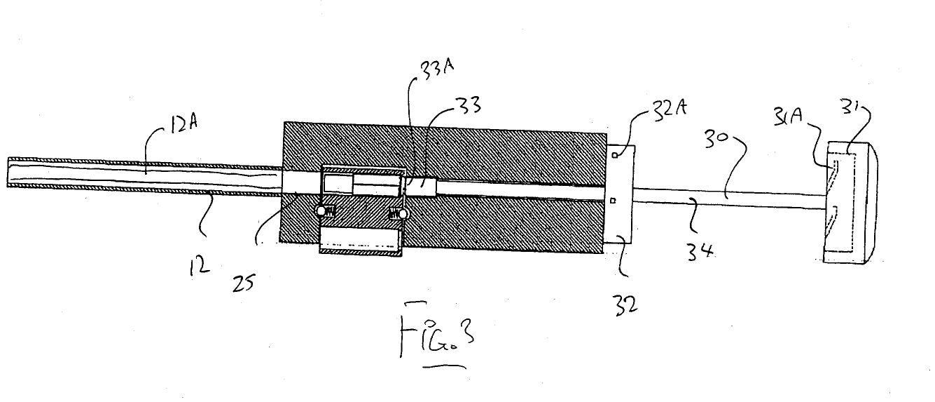

FIG. 4 is a longitudinal cross-sectional view of the embodiment of FIG. 3 on an enlarged scale.

FIG. 5 is a transverse cross-sectional view of the embodiment of FIG. 3 on an enlarged scale.

In the drawings like characters of reference indicate corresponding parts in the different figures.

### DETAILED DESCRIPTION

The embodiment shown comprises a screwdriver 10 having a generally cylindrical manually graspable handle 11, a forwardly projecting tube 12 defining a forward presentation end 13 of the tube at which is located one or a plurality of bits 14. The embodiment of the screwdriver therefore is a relatively straight forward embodiment in that the housing 11 is rotated manually which drives rotation of the tube 12 with the bit 14 at its forward end.

However other embodiments are possible within the scope of this invention including arrangements in which there is driven motor which drives the tube 12 in its rotation relative to a main body of the housing and suitable designs are well known to one skilled in the art for providing a motor within the housing and for mounting the tube in a manner which allows rotation relative to the housing. A rotatable holder 15 for the bits is mounted within the housing 11 so that a portion of the rotatable holder is exposed as indicated at 15A in a window 16 of the housing.

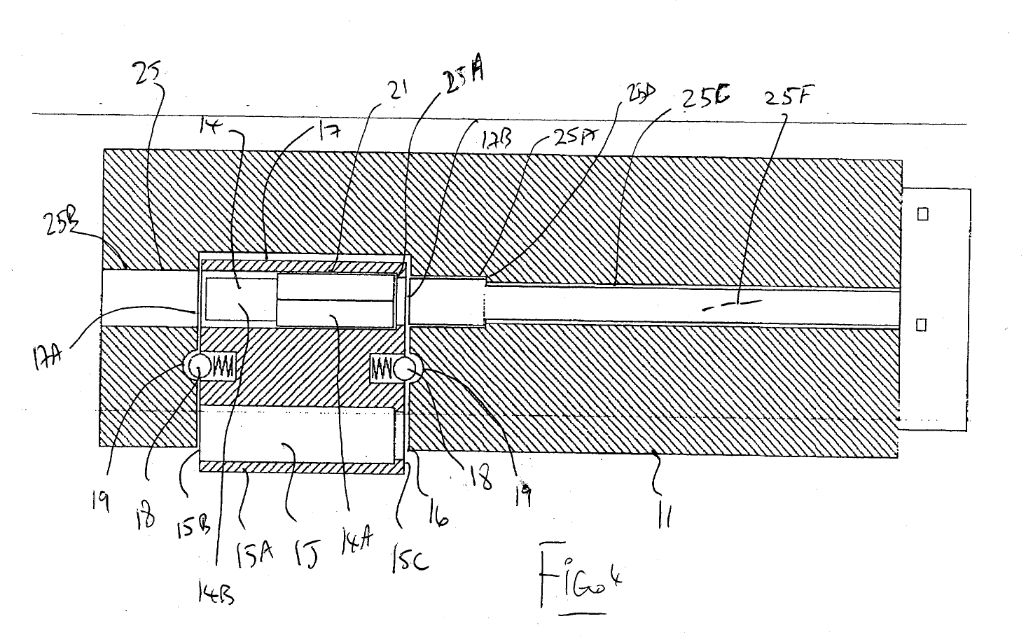

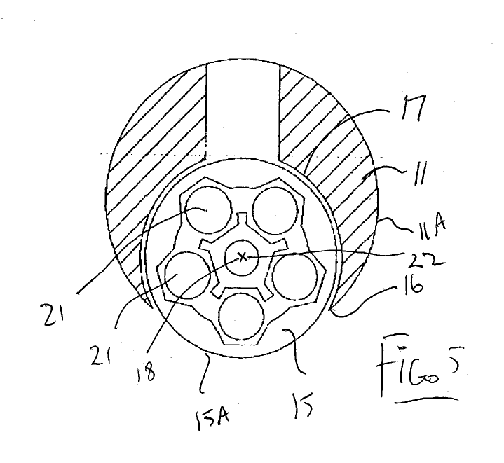

The rotatable holder 15 is cylindrical with two flat end faces and a peripheral cylindrical surface. As shown in FIGS. 4 and 5, the window 16 has a length equal to the length of the rotatable holder and has a width at the surface of the housing 11 which is just equal to the diameter of the rotatable holder so that the rotatable holder can be inserted through the window into a receptacle 17 within the housing 11. The receptacle 17 is cylindrical in shape with its axis offset from the longitudinal cylindrical axis of the cylindrical housing 11 so that the portion 15A of the rotatable holder stands proud of the cylindrical surface 11A of the housing at the window 16. The rotatable holder in the embodiment of FIGS. 4 and 5 is held in place by spring mounted balls 18 in the end faces 15B and 15C of the holder. The balls are received in a cup 19 in the end face 17A and 17B of the receptacle 17.

The holder can thus be inserted into the housing carrying a plurality of bits and can be removed for replacement by a further holder carrying different bits or can be removed for replacement for repair.

The holder comprises a cylindrical body within which is formed a plurality of recesses 21 at spaced positions around the axis 22 of the holder. Each of the recesses comprises a duct extending longitudinally through the holder from the front face 15B to the rear face 15C. Each of the ducts or recesses is cylindrical and of a diameter so that it can slidingly receive a respective one of the bits 14. The housing is thus loaded with a number of bits equal to the number of recesses which in the embodiment shown is 5 but can be more or less depending dimensions selected. Thus the rotatable holder can be rotated about its axis 22 with the balls acting as bearings and acting to locate the housing in the required position so that each of the recesses 21 in turn is moved from a storage position spaced outwardly from the axis of the housing 11 to a position lying directly along the axis of the housing.

Within the housing 11 is provided a longitudinal bore 25 which extends through the housing from the forward end at the tube 12 to the front face 17A of the receptacle 17 through which it intersects and then through the rear face 17B of the receptacle into a rear portion 25A of the bore. The forward part of the bore indicated at 25B in front of the receptacle 17 is of slightly larger diameter than a second portion 25A which is in turn slightly larger than a third portion 25C. This acts to define a shoulder 25D at which it is spaced rearwardly from the rear face 17B.

Thus when the holder is rotated so that a respective one of the receptacles 21 is located on the axis 25F of the housing then that receptacle is directly lined up with the tube 25 and its various portions.

The device further comprises a plunger 30 having an end head 31 for engagement onto an end portion 32 of the housing and also having a bit engaging head 33 at its forward end for engaging and carrying a bit from the holder to the presentation position. The plunger includes a cylindrical rod 34 which extends from the head 31 through the narrow portion 25C of the bore to the bit engaging head 33 which is received, in a retracted position of the plunger, in the section 25A of the bore. The shoulder 25D butts against a rear face of the head 33 to prevent the plunger from being pulled beyond the retracted position.

In the retracted position a front face 33A of the head 33 is just behind or aligned with the rear face 17B of the receptacle 17 just allowing clearance for the rotatable holder to be rotated when the plunger is fully retracted. The front face 33A is simply flat without any engagement with the rear face of the bit which is similarly flat which would communicate rotation between the two or requiring interengagement therebetween and the front face simply butts against the rear face of the bit when pushed forwardly.

The cap 31 includes system engagement elements 31A which co-operate with elements 32A on the rear portion of the housing so that when pushed forward the cap 31 can be rotated and clamped into place so that it can no longer move forwardly or rearwardly. This integrates the cap with the housing allowing the housing to be manually rotated while pushing on the cap.

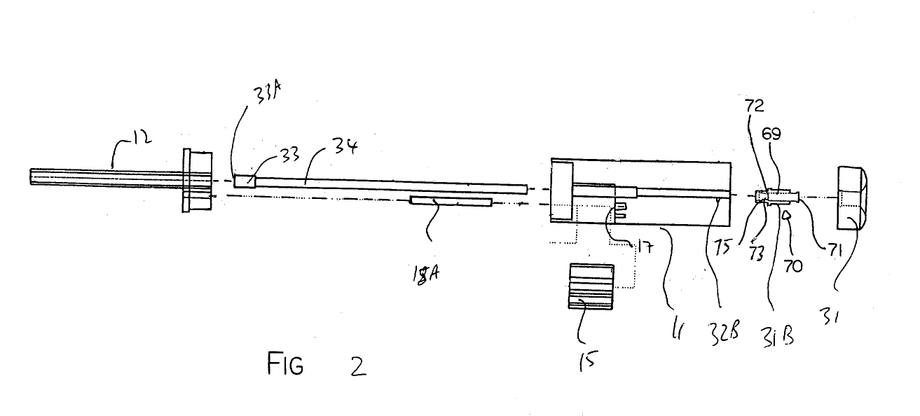

In the embodiment shown in FIG. 2 which is slightly modified the cap 31 includes a coupling element which is arranged be locked to the first end of the housing by a lock device 70 which is tubular in shape and has a hollow interior 69 and is arranged to keep the cap securely fastened to the housing and allowing the rotation, as mentioned above. The lock device has a lock shaft 72 which is located in the hollow interior 69 and has an end 71 which is arranged to be engaged by the operator located at the top end of the cap in an exposed manner and a second end 72 located in the lock device which engages a conical end 73. The conical end has the first end which is smaller in diameter that is engaged by the second end 72 and has a larger end being larger in diameter. A pair of ball bearings 75 are located on the lock device at respective sides of the conical end such that as the lock shaft is engaged the conical end moves inwardly releasing the ball bearings from engaging the housing so that the cap is unlocked and can be moved rearward from the housing. This arrangement allows the cap to rotate relative to the housing which is desirable in screw drivers.

The arrangement shown for attaching of the cap to the housing are of course only examples and other arrangements by which a cap can be temporarily held in place at the rear of the housing are well known to one skilled in the art. The cap of course requires to be the least readily for the plunger to be retracted when it is required to change one of the bits.

Also in FIG. 2 is shown a further modification in which the rotatable holder 15 is held in place by an inserted shaft 18A in replacement for the balls 18 with that shaft being inserted through an opening at the front face of the housing 11 so as to engage into a suitable recess on the axis of the rotatable housing.

The tube 12 is suitably attached at the front of the housing and extends forwardly therefrom. The tube is arranged co-axial with the bore 25 and particularly contiguous with the front portion 25B of that bore so that a bit when carried forwardly by the pushing action of the plunger is inserted into the forward portion 25B and moved from that portion into the tube 12.

While the bore 25 is cylindrical so that is has no co-action with a non circular outside surface of the bit, the tube 12 is instead shaped to match a polygonal outside surface of the bit. Thus the bit 14 includes a rear polygonal portion 14A and a front acting portion 14B shaped to provide the required action. The polygonal portion 14A is free to slide within the bore 25 and free to be received within the receptacle 21. However the tube 12 is shaped as indicated at 12A to provide a polygonal inside surface so that rotation of the tube acts to drive the bit in rotation while at its forward presented end.

The bit remains attached to the plunger in the forward position and the front face of the plunger extends to a position so that the acting portion of the bit is presented at the forward presentation position 13. It is possible to remove the bit from that location like pulling against the magnetic action but this is unnecessary and undesirable since the bits are intended to be maintained at all times within the structure and within the rotatable housing. However damaged bits could be replaced in this manner.

When the bit has used, it can be returned to its required position by disconnecting the cap 31 from the housing and pulling the plunger rearwardly. This acts to carry the bit along the tube 12A and back into the bore 25 until the head 33 is received in the portion 25A. At this point the head is halted by engagement by the shoulder 25D., A shoulder 21A may be provided in the receptacle 21 at the rear of the receptacle so as to butt against the rear face of the bit and halt the movement of the bit at a position forward of the rear face 15C. This acts to strip the bit off the magnetic head and allow the holder to be rotated manually by some engagement with the projecting portion to move the bit from its operating position to a storage position and to move another bit to the operating position. Alternatively, the bit may remain in contact with the head and be swept off the magnetic front face of the head by rotation of the rotatable holder.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A tool comprising:
a housing having a first axis therealong;
an elongate tube having a hollow interior and extending through the housing along the first axis to a forward presentation end of the tube;
the housing having a second axis adjacent to and parallel to the first axis;
a rotatable storage holder mounted in the housing for holding and storing a plurality of tool bits and arranged to rotate about the second axis;
the rotatable holder including a plurality of receptacles each for receiving a respective one of the tool bits, the receptacles being arranged parallel to the second axis and in angularly spaced relation around the second axis;
the rotatable holder and the first and second axes being arranged such that rotation of the holder causes each receptacle in turn to move from an operating position aligned with the first axis to a storage position spaced from the first axis;
a plunger mounted within the tube for forward and rearward movement therein from a retracted position, in which a forward end of the plunger is retracted rearwardly of the holder, to a forward position adjacent the forward presentation end;
the plunger having a bit carrying head at the forward end for carrying a bit from that receptacle of the holder which is in the operating position from the receptacle forwardly along the tube to the presentation end;
the holder being rotatable in the housing when the plunger is moved to the retracted position to move the receptacles to carry the bits from the operating position to the storage positions;
and a drive member on the housing for causing rotation of the bit at the forward presentation end.

2. The tool according to claim 1 wherein the rotatable holder has a portion exposed outside the housing for manual engagement such that the holding means can be rotated.

3. The tool according to claim 2 wherein the rotatable holder has a majority of its peripheral surface contained within the housing leaving only the portion exposed.

4. The tool according to claim 2 wherein the housing includes a generally cylindrical outer surface with an opening therein at which the portion is exposed and the rotatable holder includes a generally cylindrical outer surface of smaller diameter with the portion extending outside the window.

5. The tool according to claim 1 wherein the head of the plunger is magnetic which enables the plunger to hold the bit and to pull the bit back from the presentation end to the holder.

6. The tool according to claim 5 wherein head of the plunger includes a flat front face for contacting a flat rear face of the bit such that rotation of the holder sweeps the bit off the flat face of the head.

7. The tool according to claim 1 wherein the plunger includes a coupling for attachment to the housing when in the forward position such that thrust forces applied to the bit toward the housing are communicated through the plunger to the housing.

8. The tool according to claim 1 wherein the tube includes a portion rearward of the holder for receiving the head.

9. The tool according to claim 1 wherein the tube includes a shoulder for engaging an abutment on the plunger to prevent rearward retraction beyond the retracted position.

10. The tool according to claim 1 wherein the drive member on the housing is provided by a coupling between the tube and the bit by which rotation of the bit in the tube is prevented so that rotation of the tube causes rotation of the bit.

11. The tool according to claim 10 wherein a forward part of the tube is polygonal for co-operation with a polygonal portion of the bit.

12. The tool according to claim 1 wherein the tube is fixed to the housing such that rotation of the tube is caused by manual rotation of the housing.

13. The tool according to claim 1 wherein the tube includes a forward tubular duct projecting forwardly of the housing and a portion formed as a bore within the housing.

14. The tool according to claim 1 wherein the housing includes a window opposite the holder for viewing the bit aligned with the axis.
